(19) United States
(12) Patent Application Publication
(10) Pub. No.: US 2005/0116103 A1
(43) Pub. Date: Jun. 2, 2005

(54) Covering for a vehicle

(75) Inventor: Stefan Harasta, Paderborn (DE)

Correspondence Address: BIRCH STEWART KOLASCH & BIRCH, PO BOX 747, FALLS CHURCH, VA, 22040-0747, US

(73) Assignee: Goodrich Hella Aerospace Lighting Systems GmbH

(21) Appl. No.: 10/984,885

(22) Filed: Nov. 10, 2004

Related U.S. Application Data
(60) Provisional application No. 60/519,638, filed on Nov. 14, 2003.

(30) Foreign Application Priority Data
Nov. 10, 2003 (EP) 03 025 823.0

(51) Int. Cl. B64D 13/00

(52) U.S. Cl. 244/118.5

(57) ABSTRACT

A covering for a vehicle, in particular for the interior of a vehicle, e.g. for mounting above the seat rows of an airplane, comprises a covering element (22) with a front side (30) facing the interior of the vehicle when built in and a rear side (34). Further, the covering has a stiffening brace (42) for increasing the rigidity of the covering element (22), the brace being attached to the rear side (34) of the covering element (22). The stiffening brace (42) is connected with the covering element (22) in a plugged and captive manner.

### BACKGROUND OF THE INVENTION

1. Field of the Invention

The invention relates to a covering for a vehicle, in particular for the interior of a vehicle, the vehicle preferably being an aircraft.

2. Related Prior Art

As a covering, in particular the inner covering of vehicles such as airplanes, covering elements (mostly of plastic material) are employed that are secured to retaining structures of the vehicle. Thus, in an airplane, the covering elements above the seat surface, for example, are fastened to rails by special fastening elements that are attached to the covering elements. Above the seats, a plurality of different covering elements and covering units are provided that may accommodate oxygen masks, for example, or may include reading lamps, air nozzles, information panels and keys or similar operating elements. The latter units are also referred to as PSU's (Passenger Service Unit).

Covering elements or covering units of the above mentioned kind are provided above the seats in each row. Depending on the distance between the seat rows, further covering elements are present between these covering units, which are also referred to as dummy panels or “infill” panels. These covering elements are comparatively lightweight and, for reasons of simplification, partly have no fastening systems of their own for a direct fastening to the retaining structure of the vehicle to which all other covering elements or units are fastened.

Depending on the length of such covering elements, these may be rather unstable or may have poor dimensional stability. A reason for this is the material selected, which is a lightweight material such as plastic material.

To increase rigidity, prior art discloses covering elements on whose rear surfaces stiffening braces are attached by glueing. The stiffening braces are made of a light metal such as aluminum or an aluminum alloy.

EP-A-0,678,408 describes a covering element attached to a mount which in turn is fastened to a ceiling air duct above the seat rows of a bus. From DE-U-1,954,295, a suspension for a roof lining is known. DE-A-197 30 268 describes a vehicle door with holding frames as mounting supports set onto the frame of the vehicle door.

The manufacture of such stiffened covering elements is rather complex.

It is an object of the invention to provide a covering for a vehicle, in particular for the interior of a vehicle, which can be manufactured in a simplified manner, where in particular the connection between the stiffening brace and the covering element is simplified.

### SUMMARY OF THE INVENTION

To achieve this object, the invention provides a covering for a vehicle, in particular for the interior of a vehicle, e.g. for attachment above seat rows in airplanes, the covering being provided with
a covering element with a front side facing the interior of the vehicle when built in and a rear side, and
a stiffening brace for increasing the rigidity of the covering element, the brace being attached to the rear side of the covering element,
the stiffening brace being adapted for a plugged and captive connection with the covering element.

Thus, according to the invention, a mechanic plug connection is provided between the stiffening brace and the covering element. Both parts may be fitted together either by a movement directed perpendicular to the plane of the rear side or in parallel to the plane of the rear side. In both instances, a positively or frictionally engaged connection is obtained that provides for a captive retention (securing against inadvertent detachment).

The material for the covering element preferably is a plastic material, while the material from which the stiffening brace is made may be a light metal (e.g. aluminum or an aluminum alloy). Preferably, however, also the stiffening brace is made of a plastic material.

In an advantageous development of the invention, the two parts to be connected may be joined together in the manner of a groove and tongue connection or a dovetail connection. If both parts are pushed against each other in parallel to the rear side of the covering element, the cross sectional profile of the plug-in projections of the stiffening brace is complementary to the cross sectional profile of the plug receiving spaces of the covering element.

If the two parts to be connected are moved towards each other under a right angle to the rear side, the plug-in connection is effected in a manner similar to a plug-in contact. Catch noses or similar positive locking elements allow to realize a permanent positively engaged connection. As an alternative, frictional engagement is also contemplated. Both variants of a force-fit connection are also possible with the above described alternative joining of both parts.

In an advantageous embodiment of the invention, it is further contemplated that the stiffening brace and the covering element are fixedly connected using clawing elements. The clawing elements (e.g. of metal) have projections formed in the manner of barbs that claw into the stiffening brace, on the one hand, and into the covering element, on the other hand.

In an advantageous embodiment, it is provided that the stiffening brace has plug-in projections facing the covering element and being received by plug receiving spaces on the rear side of the covering element.

Preferably, the plug receiving spaces are each formed by collars protruding from the rear side of the covering element.

In another embodiment of the invention, the stiffening brace has supporting points for support at the rear side of the covering element when mounted thereon. These supporting points may be simple contact areas between parts of the stiffening brace and the covering element. At these points, there is no positively locked interconnection. Instead, other portions of the stiffening brace and the covering element are positively locked together in the manner provided by the invention. Alternatively, the supporting points coincide with the plug connection points.

Preferably, the covering element has a length and the stiffening brace extends in parallel to the length of the covering element.

In another embodiment of the invention, the stiffening brace has a substantially rectilinear or slightly curved edge portion and an opposite convex edge portion, the substantially rectilinear or slightly convex edge portion facing the rear side of the covering element when mounted thereto.

According to another advantageous embodiment of the invention, claw elements are provided between the stiffening brace and the covering element for connecting the stiffening brace with the covering element.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying drawings in which

FIG. 1 is a partial sectional view of the cabin of a plane for illustrating the mounting of covering elements above the seats of the plane,

FIG. 2 is a perspective view of the rear side of a covering element with a stiffening brace mounted thereon,

FIG. 3 is an exploded side elevational view of the covering element of FIG. 2,

FIG. 4 is a section along line IV-IV in FIG. 2 and

FIG. 5 is a perspective view of a claw element for interposition between the stiffening brace and the covering element.

### DESCRIPTION OF A PREFERRED EMBODIMENT

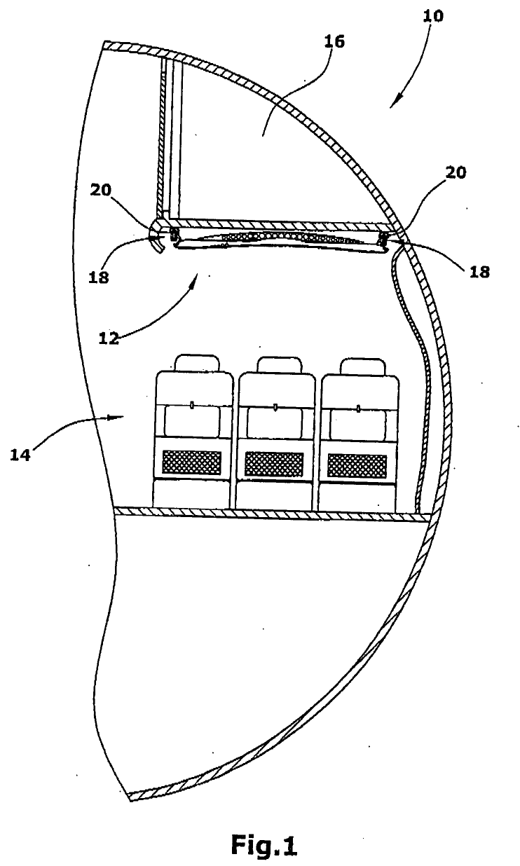

FIG. 1 illustrates a partial section through an airplane cabin 10 provided with a covering according to the invention or a covering element according to the embodiment described herein. As is evident from FIG. 1, the covering 12 is arranged above the seat rows 14 and below the overhead baggage bins 16. Thus, for example, those covering elements with built-in reading lights, ventilation nozzles, switches or oxygen masks (also referred to as first covering elements or covering elements of the first type) are fastened to C-shaped retaining profiles 20 by special fastening elements 18, while lightweight small and narrow covering elements (also referred to as second covering elements or covering elements of the second type) are hung to a respective first covering element, i.e. are not themselves directly connected to the C-shaped retaining profiles 20.

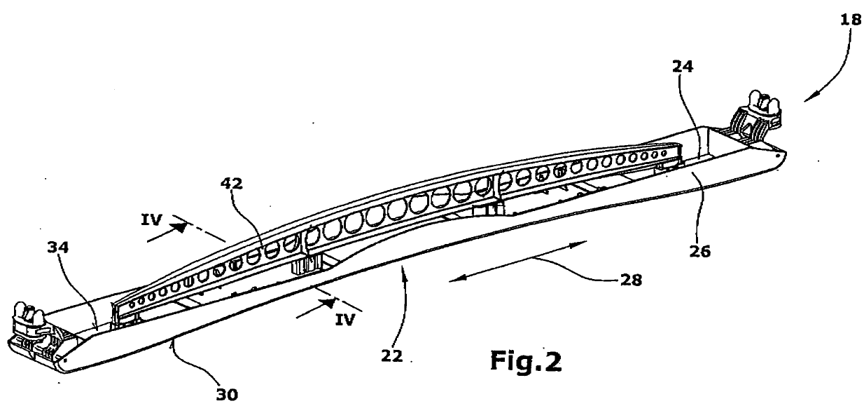

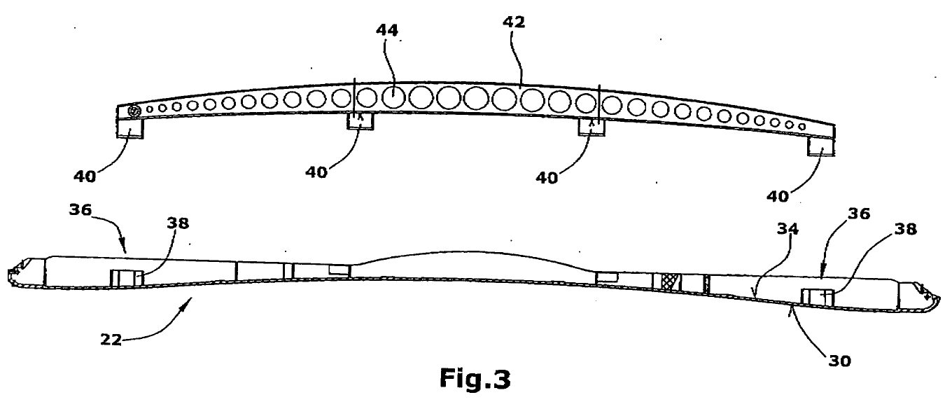

An example of a covering element 22 of the covering 12 is illustrated in FIGS. 2 and 3. This embodiment is a so-called infill panel. In principle, however, each covering element of an airplane interior covering or a vehicle covering in general may be realized according to the invention.

The covering element 22 comprises a wall 24 with a circumferentially extending upright edge 26. The narrow edges at the longitudinal ends 28 are provided with the fastening elements 18 with which the covering element 22 is fastened to the retaining structure of the airplane. The lower side of the plate 24 in FIG. 2 forms the front side 30, whereas the upper side in FIG. 2 forms the rear side 34 of the covering element 22.

On the rear side 34 of the covering element 22, a plurality (four in this embodiment) of plug receiving spaces 36 is provided, each formed by a circumferentially extending collar 38 that is substantially rectangular in top plan view. These plug receiving spaces 36 receive plug-in projections 40 of a stiffening brace 42 which, in this embodiment, is substantially arcuate in shape. In this embodiment, the stiffening brace 42 is an element with a double T-shaped section, one transverse beam being slightly convexly bent away from the rear side 34 of the covering element 22, while the second transverse beam has a stronger convex bend. To save weight, the longitudinal beam of the stiffening brace 42 connecting the two transverse beams is provided with a plurality of holes 44.

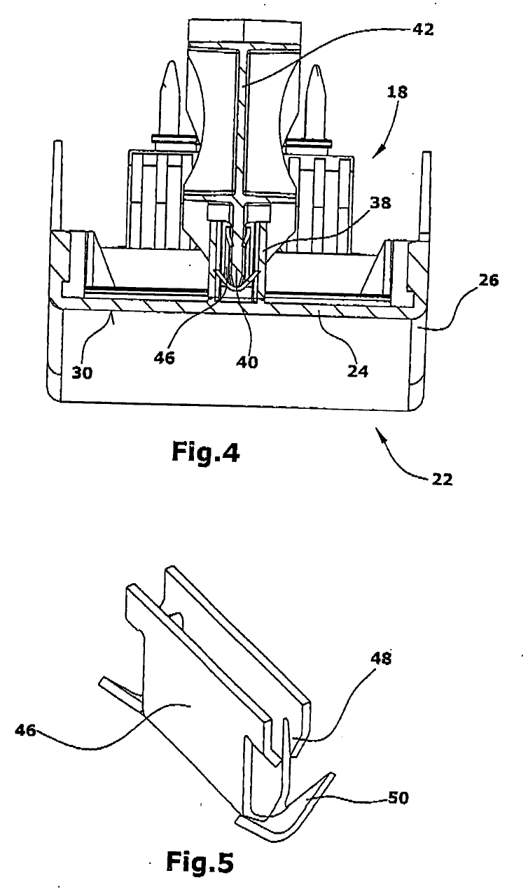

Moreover, as illustrated in FIGS. 4 and 5, for example, claw elements 46 in the form of U-shaped clamps are placed into the receiving spaces 36. A claw element 46 is made of metal and has hook elements 48 on the inside and hook elements 50 on the outside. The inner hook elements 48 engage the outside of the plug-in projections 40 of the stiffening brace 42, whereas the outer hook elements 50 engage the collars 38 of the plug receiving spaces 36 from inside (see FIG. 4). Both hook elements 48 and 50 preferably act in the manner of barbs so that a secure hold of the stiffening brace 42 on the covering element 22 is guaranteed.

Although the invention has been described and explained with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

1. A covering for a vehicle, in particular for the interior of a vehicle, e.g. for mounting above the seat rows of an airplane, comprising
a covering element (22) with a front side (30) facing the interior of the vehicle when built in and a rear side (34), and
a stiffening brace (42) for increasing the rigidity of the covering element (22), the brace being attached to the rear side (34) of the covering element (22),
the stiffening brace (42) being connected with the covering element (22) in a plugged and captive manner.

2. The covering of claim 1, wherein the stiffening brace (42) has plug-in projections (40) facing the covering element (22) and received in plug receiving spaces (36) on the rear side (34) of the covering element (22).

3. The covering of claim 2, wherein the plug receiving spaces (36) are each formed by collars (38) protruding from the rear side (34) of the covering elements (22).

4. The covering of claim 1, wherein the stiffening brace (42) has supporting points for support on the rear side (34) of the covering element (22) when mounted thereon.

5. The covering of claim 4, wherein the supporting points coincide with the plug connection points.

6. The covering of claim 1, wherein the covering element (22) has a length and the stiffening brace (42) extends in parallel to the length of the covering element (22).

7. The covering of claim 1, wherein the stiffening brace (42) has a substantially rectilinear or slightly curved edge portion and an opposite convexly bent edge portion, and wherein the substantially rectilinear or slightly convexly bent edge portion faces the rear side (34) of the covering element (22) when mounted thereto.

8. The covering of claim 1, wherein claw elements (46) are provided between the stiffening brace (42) and the covering element (22), by which the stiffening brace (42) is connected to the covering element (22).

9. The covering of claim 1, wherein the covering element (22) comprises fastening elements (18) for fastening to the retaining structure for the covering in a vehicle.
